(19) United States
(12) Patent Application Publication
(10) Pub. No.: US 2023/0302581 A1
(43) Pub. Date: Sep. 28, 2023

(54) LASER CUTTING METHOD FOR CUTTING OUT A WORKPIECE PART

(71) Applicant: TRUMPF Werkzeugmaschinen SE + Co. KG, Ditzingen (DE)

(72) Inventor: Tobias Kaiser, Rutesheim (DE)

(21) Appl. No.: 18/326,017

(22) Filed: May 31, 2023

Related U.S. Application Data
(63) Continuation of application No. PCT/EP2021/083039, filed on Nov. 25, 2021.

(30) Foreign Application Priority Data
Dec. 1, 2020 (DE) 10 2020 131 869.3

(51) Int. Cl. B23K 26/38; B23K 26/14

(52) U.S. Cl. CPC B23K 26/38; B23K 26/14

(57) ABSTRACT

A laser cutting method for cutting out a workpiece part from a metallic and plate-shaped workpiece includes cutting, using a laser beam and a cutting gas with predefined cutting parameters, the workpiece along a predefined cutting path, changing the cutting parameters in an end portion of the cutting path so that a material web remains between the workpiece part and a remaining workpiece of the workpiece. The material web fixes the workpiece part in the remaining workpiece. The method further includes cooling the workpiece in a region of the material web using the cutting gas and/or a cooling fluid, and cutting the workpiece part out of the remaining workpiece by separating the material web using the laser beam and the cutting gas.

### CROSS REFERENCE TO RELATED APPLICATIONS

This application is a continuation of International Application No. PCT/EP2021/083039 (WO 2022/117436 A1), filed on Nov. 25, 2021, and claims benefit to German Patent Application No. DE 10 2020 131 869.3, filed on Dec. 1, 2020. The aforementioned applications are hereby incorporated by reference herein.

### FIELD

Embodiments of the present invention relate to the field of laser cutting methods. In particular, embodiments of the present invention relate to a laser cutting method for cutting out a workpiece part from a metallic, in particular plate-shaped, workpiece.

### BACKGROUND

Generic methods for cutting metallic workpieces (e.g. metal sheets) comprise laser flame cutting and laser fusion cutting. In these processes, the workpiece along a predefined cutting path is fused by means of a laser beam in order for a cutting gap to be generated, and the melt is blown out of the workpiece by means of a cutting gas.

Some iron-containing metals can be cut by means of laser flame cutting by using oxygen (O₂) as cutting gas, the workpiece being heated by means of the laser beam and combusting in the oxygen jet. The energy released during combustion facilitates the cutting process. As opposed to laser flame cutting, oxidations on the cutting edges, which are created when the hot workpiece comes into contact with oxygen (O₂), are to be avoided in laser fusion cutting. For this reason, an inert cutting gas, e.g. nitrogen (N₂), is usually used in laser fusion cutting. In this case, the cutting gas not only fulfills the task of blowing the fused material out of the cutting gap. Said cutting gas simultaneously serves as a coolant for cooling the workpiece at the point of machining under a protective gas atmosphere. In this way, oxidations on the cutting edge can be avoided. Oxidations increase the susceptibility to corrosion in particular when cutting stainless steel. Moreover, tempering colors on the cutting edges, which are to be avoided for esthetic reasons, are created by the oxidations.

In principle, complex and cost-intensive post-machining of the cutting edges can thus be avoided by cooling the cutting edges under the influence of a protective gas.

When cutting a workpiece part out of a workpiece (e.g. out of a metal sheet), the cut end in this context represents a critical region, thus the region in which the workpiece part is cleanly cut from the remaining workpiece (also referred to as the sheet skeleton). The supply of cutting gas is typically interrupted in this region because the cutting head, immediately upon cleanly cutting the workpiece part, travels to the next cutting contour. As a result of the interruption in the supply of cutting gas before the workpiece part has sufficiently cooled at the cut end, the cutting edges in this region are exposed to the oxygen in the air and oxidations occur.

In order to avoid oxidations on the cut end, it is known for the cutting gas (or the cutting gas jet) to be directed onto the cutting gap for a certain amount of time after the workpiece part has been cleanly cut, so as to cool the workpiece part in the region of the cut end under the influence of the protective gas. However, one disadvantage in this procedure lies in that the workpiece part, once cleanly cut from the sheet skeleton (remaining workpiece), may fall out, or drop down or slip in the sheet skeleton, and the cutting edge as a result is no longer sufficiently covered by the protective gas jet. This disadvantage becomes more significant as the thickness of the workpiece increases. Whether and how the workpiece part falls out of the sheet skeleton depends, inter alia, on whether and how the workpiece part is supported by the workpiece support of the machine.

The workpiece part to be cut out can also fall out of the workpiece after being cleanly cut when cutting an internal contour in a workpiece to be completed, for example for forming a bore in the workpiece. It is understood that the workpiece part to be cut out in this case is not a good part but a reject, thus a waste part to be cut out. As soon as the reject falls downward out of the workpiece when being cleanly cut, the cutting gap is no longer present in its original form. This can lead to the cutting gas flow being released from the cutting edge and no longer sufficiently shielding the latter from the oxygen in the surrounding air.

When cutting takes place in the thin-sheet range (up to approximately 4 mm in terms of workpiece thickness), microjoints or nanojoints are generated in a targeted manner in the cutting gap so as to avoid workpiece parts that have been cut out from dropping down or falling out. Microjoints and nanojoints are material webs which connect an—otherwise completely cut-out—workpiece part to the surrounding sheet skeleton. Said microjoints and nanojoints can be generated in that the workpiece at predetermined locations along the cutting path is not fused at all, or not fused across the entire thickness of the workpiece. Owing to the minor workpiece thickness, the microjoints and nanojoints can be manually removed and the workpiece part thus retrieved from the sheet skeleton (for example by manually pushing the workpiece part out of the sheet skeleton). In comparison to microjoints, nanojoints have a height that is less than the workpiece thickness. As a result, the cross section of said nanojoints can be even smaller in comparison to microjoints, and the former are even easier to sever.

In the case of workpieces with a greater thickness, the workpiece parts can often no longer be manually retrieved from the sheet skeleton.

Independently from the disadvantageous formation of oxidations on the cutting edge, the cooling conditions at the cut end, which vary from those of the remaining cutting process, can also have other negative effects on the cut-out workpiece part. For example, the hot cutting edges of the workpiece part are more susceptible to undesirable deformations when the workpiece part falls out of the sheet skeleton. Disadvantageous effects of this type can arise not only in laser fusion cutting but also in laser flame cutting.

### SUMMARY

Embodiment of the present invention provide a laser cutting method for cutting out a workpiece part from a metallic and plate-shaped workpiece. The method includes cutting, using a laser beam and a cutting gas with predefined cutting parameters, the workpiece along a predefined cutting path, changing the cutting parameters in an end portion of the cutting path so that a material web remains between the workpiece part and a remaining workpiece of the workpiece. The material web fixes the workpiece part in the remaining workpiece. The method further includes cooling the workpiece in a region of the material web using the cutting gas and/or a cooling fluid, and cutting the workpiece part out of the remaining workpiece by separating the material web using the laser beam and the cutting gas.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a laser cutting machine according to an embodiment;

FIG. 2a schematically shows a workpiece with a workpiece part to be cut out of the former according to an embodiment;

FIG. 2b schematically shows the end region of a cutting path in the fragment A of FIG. 2a, according to an embodiment;

FIG. 3a schematically shows a material web, configured as a microjoint, in the cross section, according to an embodiment; and

FIG. 3b schematically shows a material web, configured as a nanojoint, in the cross section, according to an embodiment.

### DETAILED DESCRIPTION

Embodiments of the present invention can improve the homogeneity of the cutting edge, and in particular the quality of the cutting edge at the cut end, when cutting out metallic workpiece parts with a thickness of at least 4 mm, in particular of at least 10 mm.

Embodiments of the present invention provide a laser cutting method for cutting out a workpiece part from a metallic, in particular plate-shaped, workpiece. The method, in a first step, comprises cutting, by means of a laser beam and a cutting gas, and while using predefined cutting parameters, the workpiece along a predefined cutting path. The method, in a second step, comprises changing the cutting parameters in an end portion of the cutting path in such a manner that a material web remains between the workpiece part and a remaining workpiece of the workpiece, wherein the material web fixes the workpiece part in the remaining workpiece. The method, in a third step, comprises cooling the workpiece in the region of the material web by means of the cutting gas and/or by means of a suitable cooling fluid. The method, in a fourth step, comprises cleanly cutting the workpiece part out of the remaining workpiece by separating the material web by means of the laser beam and the cutting gas.

It is understood that the method steps are performed in the sequence described.

Overall, the cutting path along which the workpiece part is cut (or cut out) can form a closed contour. In the first step of the cutting, this contour is not completely closed so as to fix the workpiece part in the remaining workpiece by means of the remaining material web. The contour is completely closed and the workpiece part completely severed from the remaining workpiece only during clean cutting. Nevertheless, cutting out the workpiece part also comprises a case in which the workpiece part is situated in a peripheral region of the workpiece such that the workpiece and the workpiece part have a common external edge. In this instance, the cutting path for cutting the workpiece part out of the workpiece leads from the common external edge into the workpiece and terminates at another location of the common external edge.

The laser beam and the cutting gas can preferably exit from a common cutting head during cutting. The cutting gas can be entrained by the movement of the laser beam in a simple manner as a result. The cutting gas can in particular be directed onto the machining location of the laser beam on the workpiece in a directed jet at a predefined cutting gas pressure.

By cooling the workpiece while the workpiece part is being held in the remaining workpiece by the material web it can be prevented that the workpiece part falls out of the remaining workpiece (i.e. out of the sheet skeleton), drops down in the latter, or tilts and slowly cools under the influence of oxygen in the air. The cutting gap is kept open by the material web. As a result of the fixed position of the workpiece part, the reproducibility when cooling the workpiece part is enhanced. The active cooling of the workpiece part in the end portion of the cutting path can moreover enhance the homogeneity of the cutting edge. In other words, variations of the cutting edge in the end portion of the cutting path are reduced as a result of the cooling of the cutting edge being continued in this region.

An inert gas, in particular nitrogen (N₂), can preferably be used as the cutting gas. An inert gas which differs from the cutting gas can be used as an additional or alternative cooling fluid. Helium (He) can in particular be used as an additional or alternative cooling fluid. An inert gas is distinguished by its sluggish reaction to the material of the workpiece to be cut at the prevailing process temperatures. While nitrogen (N₂) is also inert in many applications, helium (He) has a better thermal conductivity in comparison to nitrogen (N₂). Therefore, the cooling process can be further optimized by using helium (He) as an additional or alternative cooling fluid.

According to one variant, the cooling of the workpiece can comprise: Switching off the laser beam for a predetermined period of time, preferably for less than 5 seconds, in particular for less than one second. The heating of the workpiece associated with the laser radiation is interrupted by switching off the laser beam.

The cooling of the workpiece can furthermore comprise: Impinging the region of the workpiece to be cooled with the cutting gas while the laser beam is switched off, wherein a cutting gas pressure during the cooling is higher than or equal to a cutting gas pressure during the cutting of the workpiece. By blowing the cutting gas into the cutting gap in the region to be cooled, the workpiece cools down in this region. In principle, the cooling process can be accelerated by increasing the cutting gas pressure. An additional acceleration of the cooling process can be achieved by additionally impinging the region to be cooled with a water mist or any other suitable cooling fluid. Such an additional cooling fluid can be directed onto the cutting gap by way of a transverse blower nozzle, for example. In principle, the workpiece can also be cooled exclusively by means of a cooling fluid that differs from the cutting gas by way of a transverse blower nozzle.

For economical reasons, it is desirable in principle that the cooling time is kept short. One objective lies in visually adapting the cutting edge of the workpiece part in the end portion of the cutting path to the remainder of the cutting edge. Depending on the individual requirements in terms of the visual impact of the cutting edge, it may suffice to cool the workpiece for less than one second, as described above. It may be necessary for the cooling time to be increased in particular with an increasing workpiece thickness.

According to one variant, the material web can have a predetermined minimum cross section such that the workpiece part is just still fixed in the original position thereof in the remaining workpiece during the cooling. The cross section of the material web is determined by way of the height and the width of the material web. The height of the material web can correspond at most to the thickness of the workpiece. The width of the material web corresponds to the extent of the material web in the cutting direction. The material web moreover has a length which corresponds to the width of the cutting gap.

As a result of the workpiece part being fixed or held in its original position in the remaining workpiece, the workpiece part cannot tilt in the remaining workpiece or fall out of the latter. This has the advantage that the cutting gap is kept open. In this way, the cutting edge of the workpiece part in the end portion of the cutting path continues to be accessible to the cutting gas. The cross section of the material web should thus be large enough to guarantee sufficient stability of the material web. On the other hand, the cross section of the material web should be ideally small so as to minimize the energy input into the workpiece required for cleanly cutting the workpiece. It is understood that the minimally required cross section of the material web depends on a plurality of factors. These factors include the material of the workpiece, the volume of the workpiece part (or the weight of the latter), and the position of the center of gravity of the workpiece part in relation to the material web, and whether or at how many locations the part to be cleanly cut is supported by the workpiece support of the machine.

According to one variant, the changing of the cutting parameters can comprise the following sub-step: Switching off the laser before the end of the cutting path is reached when cutting the workpiece.

The end of the cutting path can in particular be the position on the cutting path where the contour to be cut is closed.

By switching off the laser beam shortly before the end of the cutting path, the material web can be configured as a so-called “microjoint”. In this case, the material web can have a height which corresponds to the thickness of the workpiece. The width of the material web should be as small as possible. The optimum width of the material web depends on the moment of tilt that the material web has to withstand in order to hold the workpiece part.

A microjoint can be generated in a simple manner without requiring the cutting parameters to be adapted in a complex manner. To this end, the laser beam has only to be switched off at a location shortly before reaching the end of the cutting path.

According to an alternative variant, the changing of the cutting parameters can comprise the following steps: Changing the cutting parameters in such a manner that the workpiece is fused only down to a depth which is less than the workpiece thickness; and cutting the workpiece up to the end of the cutting path while using the changed cutting parameters such that the material web has a height which is less than the workpiece thickness.

In this way, the material web can be configured as a so-called “nanojoint”. The cross section of the material web can be further reduced by reducing the height of the material web in comparison to the microjoint.

The changing of cutting parameters for generating a nanojoint is described in the Patent Application WO 2019025327 A2 of the applicant, for example.

The changing of the cutting parameters for generating a nanojoint can comprise, for example, a reduction in a laser output, an increase in a cutting rate and/or a variation of a focal position or of a focal diameter of the laser beam. For cooling the workpiece in the region of the nanojoint it can be provided that the cutting head is moved back along the cutting path across the width of the nanojoint, while the cutting gas is blown out of the cutting head into the cutting gap. Alternatively, the cutting gas can be directed primarily onto the last cut end of the nanojoint. In this case, the cutting head does not have to be moved back.

The clean cutting of the workpiece part out of the remaining workpiece can comprise the following sub-steps: Switching on the laser; and cleanly cutting the workpiece part out of the remaining workpiece by separating the material web by means of the laser beam and the cutting gas, wherein the cutting parameters when cleanly cutting the workpiece part are adjusted such that less energy is coupled into the workpiece than in the preceding cutting of the workpiece.

In principle, the separating of the material web for cleanly cutting the workpiece part can take place according to the same principle as the cutting of the workpiece. It is therefore understood that the same cutting parameters as in the preceding cutting of the workpiece are also used for cleanly cutting the workpiece part. As a result of the short dwell time of the laser beam when severing the microjoint or nanojoint (i.e. the material web), also in this case less heat is introduced into the workpiece than when cutting the workpiece over longer distances. As a result of the workpiece being heated to a lesser extent when being cleanly cut, the formation of oxidations on the cutting edge of the workpiece part after clean cutting can be reduced.

The adjusting of the cutting parameters when cleanly cutting the workpiece part can comprise a reduction in a laser output and/or an increase in a cutting rate and/or a variation of a focal position and/or of a focal diameter of the laser beam. Additionally or alternatively, the pressure of the cutting gas for cleanly cutting the workpiece part can also be increased. The increased pressure of the cutting gas can positively influence the cooling effect on the workpiece part even during the clean cutting. It is understood that the relative details for adjusting the cutting parameters relate to the corresponding cutting parameters in the preceding cutting of the workpiece.

Depending on the position of the cutting head after the cooling of the workpiece, the material web can be cut off (i.e. separated) either in the original cutting direction or counter to the original cutting direction. In the case of a microjoint it can be provided that the cutting heads remains stationary during the cooling at the end of the microjoint that is the front end in the cutting direction, that is to say at the position at which the laser beam has been switched off. The clean cutting in this case can take place in the same direction as the preceding cutting of the workpiece. In contrast, in the case of a nanojoint, it can be provided that the cutting head remains stationary during the cooling at the end of the nanojoint that is the rear end in the cutting direction. In this case, the clean cutting can take place in a direction counter to the preceding cutting direction. An additional respective displacement path of the cutting head can be avoided in this way.

The workpiece can have a thickness of at least 4 mm, preferably of at least 10 mm. The workpiece can in particular be a metal sheet. The advantageous effects of the method according to embodiments of the invention are particularly apparent when cutting in the thick sheet range. This is associated with the fact, inter alia, that the heat input into the workpiece increases with the increasing thickness of the workpiece. For example, the workpiece can also have a thickness of 40 mm or more.

Embodiments of the present invention provide a laser cutting machine for cutting metallic, in particular plate-shaped, workpieces, said laser cutting machine being configured to carry out the laser cutting method according the embodiments described above.

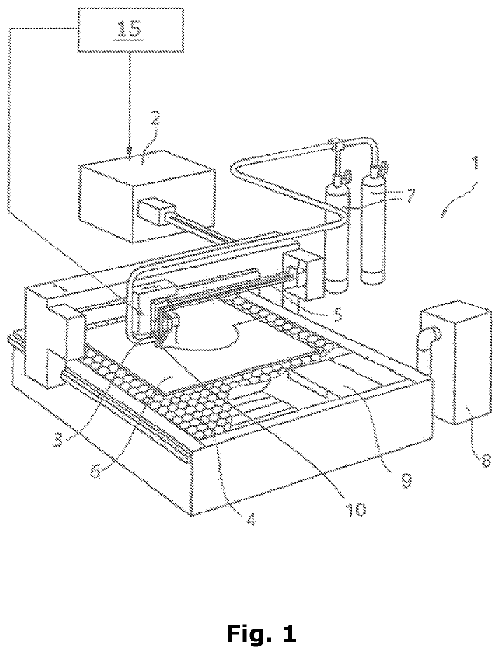

FIG. 1 by way of example shows a laser cutting machine 1 which is suitable for carrying out a method according to embodiments of the invention. The laser cutting machine 1 comprises a laser beam generator 2 (e.g. a CO₂ laser, diode laser, or solid-state laser), a displaceable cutting head 3, and a workpiece support 4. A laser beam 5 which is guided from the laser beam generator 2 to the machining head 3 by means of an optical fiber (not shown) or deflection mirrors (not shown) is generated in the laser beam generator 2. A plate-shaped workpiece 6 is disposed on the workpiece support 4. The laser beam 5 is directed onto the workpiece 6 by means of a focusing optical unit arranged in the machining head 3. The laser cutting machine 1 is moreover supplied with cutting gas 7, for example nitrogen (N₂). The use of the respective cutting gas 7 depends on the workpiece material and on quality requirements set for the cutting edges. There is furthermore a suction installation 8 which is connected to a suction duct 9, the latter being situated below the workpiece support 4. The cutting gas 7 is supplied to a cutting gas nozzle 10 of the cutting head 3, from which said cutting gas 7 exits conjointly with the laser beam 5.

During laser beam cutting, the workpiece 6 while using predefined cutting parameters, is fused along a predefined contour by means of the laser beam 5, and blown out downwards by means of the cutting gas 7, a cutting gap being created as a result. The laser cutting machine 1 furthermore comprises a control unit 15 for controlling the cutting parameters.

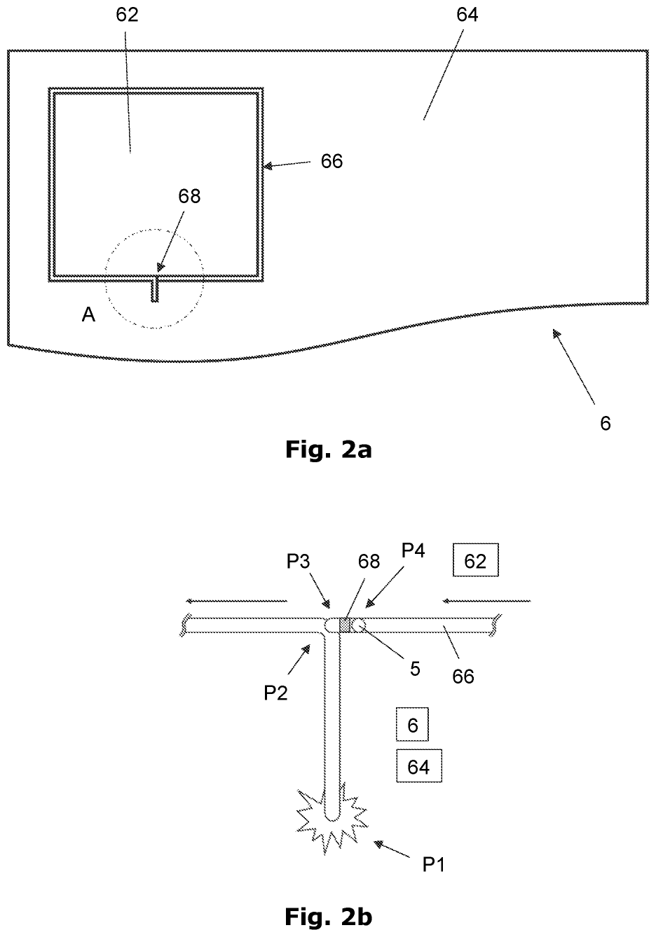

Aspects of a method according to embodiments of the present invention will be explained in more detail hereunder by means of FIGS. 2a and 2b. Schematically illustrated in FIG. 2a is a fragment of a plate-shaped workpiece 6 in the view from above. Configured along a closed, rectangular contour in the workpiece 6 is a cutting gap 66 which divides the workpiece 6 into a workpiece part 62 (or a cut part or good part) and a remaining workpiece 64 (or sheet skeleton). However, the cutting gap 66 does not completely close the contour. In this way, the cutting gap 66 is interrupted by a material web 68 which connects the workpiece part 62 to the remaining workpiece 64 and fixes the former in the latter. A method according to embodiments of the present invention can be applied for cutting the workpiece part 62 out of the workpiece 6. The cutting of the workpiece 6 (in the clockwise direction in FIG. 2a) takes place while using predefined cutting parameters which depend, inter alia, on the thickness and the material of the workpiece 6. The cutting parameters in an end portion of the cutting path are changed in such a manner that the material web 68 which fixes the workpiece part 62 in the remaining workpiece 64 is created. This can be achieved in particular in that the laser beam 5 is switched off before reaching the end of the cutting path, so as to generate a microjoint. Alternatively, the cutting parameters in the end portion of the cutting path can be changed, e.g. by reducing the laser beam output, in such a manner that the workpiece 6 in this portion is no longer cut across the entire thickness. In this way, the material web 68 can be configured as a nanojoint.

FIG. 2b shows the fragment A from FIG. 2a. The progression of the cutting process can be reconstructed by means of FIG. 2b. The laser beam 5 cuts into the workpiece 6 at the position P1 and is displaced to the contour to be cut, reaching the latter at position P2. Subsequently, the laser beam 5 moves along the contour of the workpiece part 62 and, while interacting with the cutting gas 7, generates the continuous cutting gap 66. When reaching the position P3 shortly before the end of the cutting path (position P4), the cutting parameters are changed in such a manner that the material web 68 is created as a microjoint or as a nanojoint. The material web 68 is configured so as to be sufficiently stable to hold the workpiece part 62 in the remaining workpiece 64 and to prevent tilting of the workpiece part 62 in relation to the remaining workpiece 64.

Once the material web 68 has been generated, the laser beam 5 can be switched off according to embodiments of the invention, while the cutting gas 7 continues to be directed onto the material in the region of the material web 68, which has been heated by the laser beam 5. While it may be advantageous to use the same inert protective gas, in particular nitrogen (Na) when cutting the workpiece 6 as well as when cooling, this is not mandatory. Alternatively, it is possible, for example, to initially cut using nitrogen (Na) as a process gas, and to switch over to another inert gas, e.g. helium (He) (as a cooling fluid) for cooling the cutting edges at the end of the cutting gap. Owing to the good thermal conductivity of helium (He), as a result of the use of the latter as a protective gas the cooling effect can be further increased and the cooling time reduced in comparison to nitrogen (N₂). In order to achieve only uniform cooling of the cutting edge of the workpiece 62 irrespective of oxidations, it is also conceivable that the method according to embodiments of the invention is carried out in a flame cutting process using oxygen (O₂) as a cutting gas. In this case, the advantages of the method according to embodiments of the invention can lie in particular in increasing the homogeneity of the cutting edge.

The cooling process can be accelerated by increasing the gas pressure.

Once the workpiece 6 has cooled sufficiently, the laser beam 5 is switched on again and the workpiece part 62 is cleanly cut by separating the material web 68. The target temperature of the workpiece 6 after cooling depends on the objective of the cooling and varies inter alia as a function of the material of the workpiece 6. It can be intended in particular to reduce the oxide formations on the cutting edge when cutting stainless steel, so as to avoid tempering colors of the cutting edge. Depending on the thickness of the workpiece, a substantial reduction in tempering colors on the cutting edge can already be achieved with a cooling period of less than one second in comparison to a conventional method in which the workpiece 6 is completely cut out (thus also cleanly cut) without any cooling break.

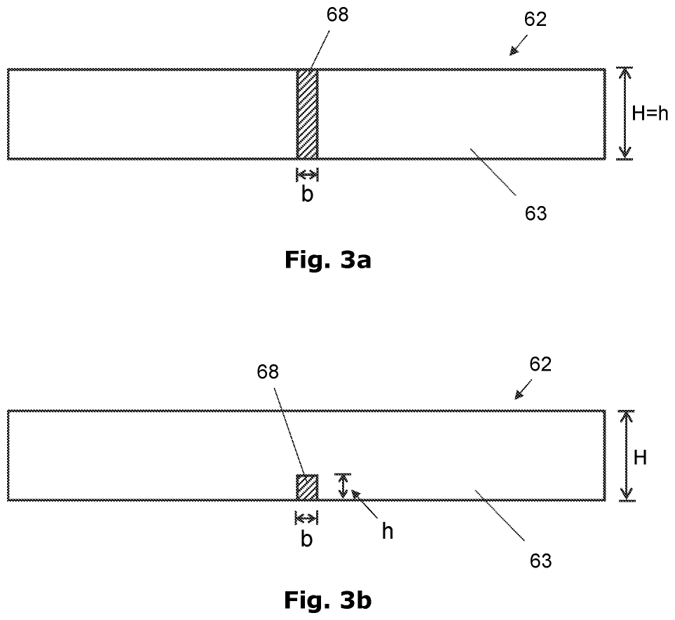

FIGS. 3a and 3b schematically show a sectional view through a material web 68 which is configured as a microjoint (FIG. 3a) or as a nanojoint (FIG. 3b), respectively. The drawing plane of FIGS. 3a and 3b extends in each case along the cutting gap 66 parallel to the cutting edge 63 of the workpiece part 62 (thus perpendicular to the workpiece surface). In order for the material web 68 to have sufficient stability to hold or fix the workpiece part 62 in the remaining workpiece, the former must have a minimally required cross section. The cross section of the material web 68 can be determined approximately by way of the height h and the width b of the material web 68. It is understood here that the cross-sectional shape of the material web 68 in practice typically deviates from the simplified rectangular shape according to FIGS. 3a and 3b. Methods for determining non-rectangular cross sections are likewise known to the person skilled in the art.

FIG. 3a shows a material web 68 which is configured as a microjoint, the height h thereof corresponding to the thickness H of the workpiece 6. FIG. 3b, for comparison, shows a material web 68 which is configured as a nanojoint, the height h thereof being less than the thickness H of the workpiece 6. In principle, the cross section of the material web 68 should be kept as small as possible so that the heating of the workpiece can also be kept ideally low when separating the material web 68. In the case of a microjoint (FIG. 3a), the cross section of the material web 68 can be controlled only by way of the width of the material web 68. It may be advantageous for the material web 68 to be configured as a nanojoint (FIG. 3b) in particular when cutting workpieces 6 with a large thickness H, for example of more than 10 mm. In this case, the cross section of the material web, in addition to the width b, can also be controlled by way of the height h of said material web. This increases the possibilities in terms of configuring a material web of the optimum size.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser cutting method for cutting out a workpiece part from a metallic and plate-shaped workpiece, the method comprising:
cutting, using a laser beam and a cutting gas with predefined cutting parameters, the workpiece along a predefined cutting path;
changing the cutting parameters in an end portion of the cutting path so that a material web remains between the workpiece part and a remaining workpiece of the workpiece, wherein the material web fixes the workpiece part in the remaining workpiece;
cooling the workpiece in a region of the material web using the cutting gas and/or a cooling fluid; and
cutting the workpiece part out of the remaining workpiece by separating the material web using the laser beam and the cutting gas.

2. The method as claimed in claim 1, wherein the cutting gas comprises an inert gas.

3. The method as claimed in claim 1, wherein the cooling of the workpiece comprises:
switching off the laser beam for a predetermined period of time.

4. The method as claimed in claim 3, wherein the predetermined period of time is less than 5 seconds.

5. The method as claimed in claim 3, wherein the cooling of the workpiece furthermore comprises:
impinging the region to be cooled with the cutting gas while the laser beam is switched off, wherein a cutting gas pressure during the cooling is higher than or equal to a cutting gas pressure during the cutting of the workpiece.

6. The method as claimed in claim 1, wherein the material web has a predetermined minimum cross section such that the workpiece part is fixed in an original position in the remaining workpiece during the cooling.

7. The method as claimed in claim 1, wherein the changing of the cutting parameters comprises:
switching off the laser beam before an end of the cutting path is reached when cutting the workpiece.

8. The method as claimed in claim 1, wherein the changing of the cutting parameters comprises:
changing the cutting parameters so that the workpiece is fused down to a depth that is less than the workpiece thickness; and
cutting the workpiece to an end of the cutting path while using the changed cutting parameters such that the material web has a height that is less than the workpiece thickness.

9. The method as claimed in claim 1, wherein the cutting the workpiece part out of the remaining workpiece comprises:
switching on the laser beam; and
cutting the workpiece part out of the remaining workpiece by separating the material web using the laser beam and the cutting gas, while the cutting parameters are adjusted so that less energy is coupled into the workpiece than while cutting the workpiece along the predefined cutting path.

10. The method as claimed in claim 9, wherein the cutting parameters while cutting the workpiece part are adjusted so that a laser output is reduced.

11. The method as claimed in claim 9, wherein the cutting parameters while cutting the workpiece part are adjusted so that a cutting rate is increased.

12. The method as claimed in claim 9, wherein the cutting parameters while cutting the workpiece part are adjusted so that a focal position and/or of a focal diameter of the laser beam are varied.

13. The method as claimed in claim 1, wherein the workpiece has a thickness of at least 4 mm.

14. A laser cutting machine for cutting metallic and plate-shaped workpieces, wherein the laser cutting machine is configured to carry out the laser cutting method as claimed in claim 1.
